(19) United States
(12) Patent Application Publication
(10) Pub. No.: US 2026/0095614 A1
(43) Pub. Date: Apr. 2, 2026

(54) Television Remote Locating System

(71) Applicant: Ryan Gennett, Parrish, FL (US)

(72) Inventor: Ryan Gennett, Parrish, FL (US)

(21) Appl. No.: 19/338,477

(22) Filed: Sep. 24, 2025

Related U.S. Application Data
(60) Provisional application No. 63/699,837, filed on Sep. 27, 2024.

(51) Int. Cl. H04N 21/422

(52) U.S. Cl. CPC H04N 21/42222

(57) ABSTRACT

A television remote locating system is provided. The system is comprised of a remote control integrated with a speaker configured to emit an audible locating tone upon receiving an activation signal. The remote control may further include a light-emitting indicator to provide additional or alternative visual assistance during low-light conditions, synchronized with the audible alert. The activation signal may be initiated through one or more input methods, including a manually operated button integrated into or affixed to a television housing, a voice command processed by a microphone and voice recognition module associated with the button, or a command issued through a graphical user interface presented on a smartphone application. The system enables users to initiate a locating alert, follow the audible and visual signals to retrieve the remote, and deactivate the alert through a repeat input via any compatible interface.

### CROSS-REFERENCE TO RELATED APPLICATION

The present application claims priority to, and the benefit of, U.S. Provisional Application No. 63/699,837, which was filed on Sep. 27, 2024, and is incorporated herein by reference in its entirety.

### FIELD OF THE INVENTION

The present invention relates generally to the field of television remotes. More specifically, the present invention relates to a remote control with an integrated speaker and optional light-emitting indicator configured to emit audible and visual locating alerts upon receiving an activation signal, wherein the activation signal may be initiated via a television-mounted button, voice command, or smartphone application. Accordingly, the present disclosure makes specific reference thereto. Nonetheless, it is to be appreciated that aspects of the present invention are also equally applicable to other like applications, devices, and methods of manufacture.

### BACKGROUND

In many households, misplacement of television remote controls is a frequent and recurring problem. This issue is particularly prevalent in environments with young children or pets, where remotes may be unintentionally relocated, dropped, or concealed beneath furniture. Common hiding places include under sofas, between couch cushions, or behind furniture items, making manual searching time-consuming and inefficient. Additionally, users are often unaware of the remote's battery status, which can lead to unexpected power loss during use. This interruption can occur at inconvenient times, disrupting media consumption and reducing overall user satisfaction. Existing methods for addressing misplaced remotes, such as manual searching or third-party tracking devices, are either ineffective or cumbersome to implement. Moreover, traditional remotes lack integrated mechanisms for self-location, and available solutions may not be compatible with all types of televisions or remote models. These challenges highlight the need for a streamlined and integrated solution to efficiently locate television remotes and manage their operational readiness.

Therefore, there exists a long-felt need in the art for a television remote locating system that enables users to quickly locate misplaced remote controls through audible and visual alerts. There also exists a long-felt need in the art for a television remote locating system that supports activation through multiple input methods including television-mounted buttons, voice commands, and smartphone applications. Moreover, there exists a long-felt need in the art for a television remote locating system that alerts users to the remote's status and reduces disruptions caused by battery depletion or device misplacement.

The subject matter disclosed and claimed herein, in one embodiment thereof, comprises a television remote locating system. The system is comprised of a remote control integrated with a speaker configured to emit an audible locating tone upon receiving an activation signal. The remote control may further include a light-emitting indicator to provide additional or alternative visual assistance during low-light conditions, synchronized with the audible alert. The activation signal may be initiated through one or more input methods, including a manually operated button integrated into or affixed to a television housing, a voice command processed by a microphone and voice recognition module associated with the button, or a command issued through a graphical user interface presented on a smartphone application. The smartphone application may support both voice and manual input and may be configured to communicate with the remote through wireless protocols. The system may comprise a wireless transceiver integrated into the remote control, television, activation button, or any combination thereof to support device synchronization. The system enables users to initiate a locating alert, follow the audible and visual signals to retrieve the remote, and deactivate the alert through a repeat input via any compatible interface.

In this manner, the television remote locating system of the present invention accomplishes all the forgoing objectives and provides a system that enables users to rapidly identify the location of a misplaced remote using audible and visual signals. The integration of activation mechanisms into the television, voice input modules, and a smartphone application further ensures accessibility through multiple convenient methods. By reducing time spent searching for remotes, the television remote locating system significantly improves user convenience and addresses a longstanding issue encountered in modern households.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a television remote locating system. The system is designed to enhance user convenience by enabling the efficient location of misplaced television remote controls. The system is comprised of a remote control integrated with an audible alert mechanism, which may be activated through various user interfaces including a manual button mounted on a television, a voice command detected by a voice input sensor, or a graphical interface on a smartphone application.

The remote control is further comprised of a speaker configured to emit audible tones. In additional embodiments, the speaker may have a light-emitting indicator configured to flash in synchronization with the tone to improve visibility in low-light environments. The locating tone comprises a sequence of audible signals such as modulated beeps, musical tones, spoken prompts, or frequency sweeps. The signal may be selected or adjusted via the application, a manual button on the television, or through the television interface. The tone may repeat at defined intervals or continue until manually or automatically deactivated.

More specifically, the manual button may be installed or integrated into the television housing. The button may be built-in during manufacturing or retrofitted using fasteners. Activation of the button triggers the remote control to emit the locating tone until deactivated by the user. The button may include a microphone connected to a voice recognition module configured to interpret voice commands such as “find my remote.” Upon recognition, a signal is transmitted to activate the speaker on the remote control. Additional commands may be supported to deactivate the tone or perform other functions. Power is provided to the button via an adapter connected to a television port.

The system is further comprised of a smartphone application with a graphical user interface. A primary feature allows the user to initiate the locating tone via touch input or voice command processed by the smartphone's onboard voice recognition. The application communicates with the system through a compatible wireless protocol.

A method of use is also provided. First, the system comprising a remote control with a speaker, optionally a light-emitting indicator, at least one battery, and optionally a charging port is provided. The user then activates the locating tone by using a button on the television, a voice command detected by a microphone and processed by a voice recognition module, or through the smartphone application. The remote control can then be located by following the emitted tone and/or flashing light. The tone and indicator may then be deactivated by reactivating the button, using the smartphone application, or issuing a recognized voice command.

Accordingly, the television remote locating system of the present invention is particularly advantageous as it provides a system that enables users to rapidly identify the location of a misplaced remote using audible and visual signals. The integration of activation mechanisms into the television, voice input modules, and a smartphone application further ensures accessibility through multiple convenient methods. By reducing time spent searching for remotes, the television remote locating system significantly improves user convenience and addresses a longstanding issue encountered in modern households. In this manner, the television remote locating system overcomes the limitations of existing television remotes and methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a remote of one potential embodiment of a television remote locating system of the present invention in accordance with the disclosed architecture;

FIG. 2 illustrates a front view of a television of one potential embodiment of a television remote locating system of the present invention in accordance with the disclosed architecture;

FIG. 3 illustrates a graphical block diagram of features of a mobile application of one potential embodiment of a television remote locating system of the present invention in accordance with the disclosed architecture; and

FIG. 4 illustrates a flowchart of a method of using one potential embodiment of a television remote locating system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a television remote locating system that enables users to quickly locate misplaced remote controls through audible and visual alerts. There also exists a long-felt need in the art for a television remote locating system that supports activation through multiple input methods including television-mounted buttons, voice commands, and smartphone applications. Moreover, there exists a long-felt need in the art for a television remote locating system that alerts users to the remote's status and reduces disruptions caused by battery depletion or device misplacement.

The present invention, in one exemplary embodiment, is comprised of a television remote locating system. The system enhances user convenience by enabling rapid and efficient identification of misplaced television remote controls. The system is comprised of a remote control integrated with an audible alert mechanism that may be triggered through various user interfaces, including a manual button on a television, a voice command processed by a voice input sensor, or a graphical interface provided by a smartphone application.

The remote control is further comprised of a speaker configured to emit audible tones. In additional embodiments, the speaker may be paired with a light-emitting indicator that flashes in synchronization with the emitted tone to improve visibility in low-light environments. The locating tone comprises a sequence of audible signals, including modulated beeps, musical tones, spoken prompts, or frequency sweeps. Selection or adjustment of the signal may be performed via the application, the manual television button, or through a television interface. The tone may be configured to repeat at defined intervals or continue until deactivation is manually or automatically executed.

More specifically, the manual button may be either integrated into the television housing during manufacturing or retrofitted using appropriate fasteners. Activation of the button prompts the remote control to emit the locating tone until the user deactivates the signal. The button may also be comprised of a microphone linked to a voice recognition module capable of interpreting voice commands such as “find my remote.” Upon successful recognition, the module transmits a signal to activate the speaker within the remote control. Additional voice commands may be supported for tone deactivation or other functions. Power to the button is supplied via an adapter connected to a designated television port.

The system additionally comprises a smartphone application featuring a graphical user interface. A core function of the application enables the user to initiate the locating tone using either touch input or a voice command processed by the smartphone's onboard voice recognition system. The application communicates with the system using a compatible wireless protocol.

A method of use is also provided. Initially, the system is provided. The user activates the locating tone using one of the following input methods: a button on the television, a voice command processed by a voice recognition module, or through the smartphone application. The remote control is then located by following the emitted audible tone and/or flashing light. Deactivation of the tone and indicator may be achieved by reactivating the button, interacting with the smartphone application, or issuing a recognized voice command.

As a result, the device enables users to efficiently locate a misplaced remote through audible and visual cues. Integration of activation interfaces within the television, voice input modules, and the smartphone application ensures accessibility through multiple convenient methods. This system reduces the time typically spent searching for remote controls, significantly enhancing user convenience and addressing a persistent issue in modern households. As such, the television remote locating system effectively resolves limitations associated with conventional remote controls and known locating methods.

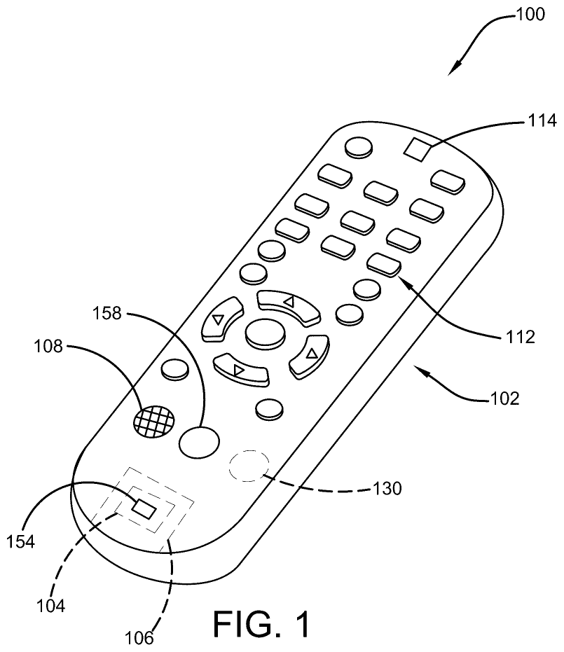

Referring initially to the drawings, FIG. 1 illustrates a perspective view of a remote 102 of one potential embodiment of a television remote locating system 100 of the present invention in accordance with the disclosed architecture. The system 100 is designed to improve user convenience by enabling the quick and efficient location of misplaced television remote controls. The system 100 may be comprised of a remote control 102 integrated with an audible alert mechanism, which may be activated through multiple user interfaces including but not limited to a manually-operated button 122 mounted on a television 120, a voice command processed via a voice input sensor 126, or a graphical user interface displayed by a smartphone application 140.

The remote control 102 may be of any type and design configured to operate with a television 120 or similar display device. The remote control 102 may be comprised of one or more batteries 104 housed within a battery compartment 106. The batteries 104 may be disposable or rechargeable and may be of various chemistries such as but not limited to alkaline, lithium-ion, or nickel-metal hydride. A charging port 154 may optionally be provided on the housing of the remote control 102 to support recharging of the battery 104 in one embodiment.

The remote control 102 is further comprised of a speaker 108 configured to emit audible tones. In additional embodiments, the speaker 108 may be paired with a light-emitting indicator 158 such as but not limited to any combination of an LED, strobe, or OLED-based signal light, configured to flash in synchronization with the audible tone to improve visibility of the remote control 102 in low-light conditions.

The locating tone emitted by the speaker 108 may be comprised of a sequence of audible signals including but not limited to any combination of modulated beeps, musical tones, spoken prompts, or frequency sweeps, which may be selected or adjusted by the user through settings within the application 140, remote buttons 112, button 122, and/or the television 120. The tone may be configured to repeat at defined intervals or continue indefinitely until deactivation is manually or automatically triggered.

The remote control 102 may include a plurality of buttons 112 such as but not limited to any combination of volume control buttons, channel selection buttons, directional navigation buttons, input source selection buttons, power buttons, numeric entry buttons, menu access buttons, and other function-specific buttons depending on the device to be controlled. The layout and type of buttons 112 may vary depending on the intended user interface design and device compatibility.

Communication between the remote control 102 and the television 120 may be achieved using a communication interface 114, which may be comprised of but not limited to any combination of an infrared (IR) emitter, a radio frequency (RF) transceiver, a Bluetooth transceiver, or similar wireless communication hardware.

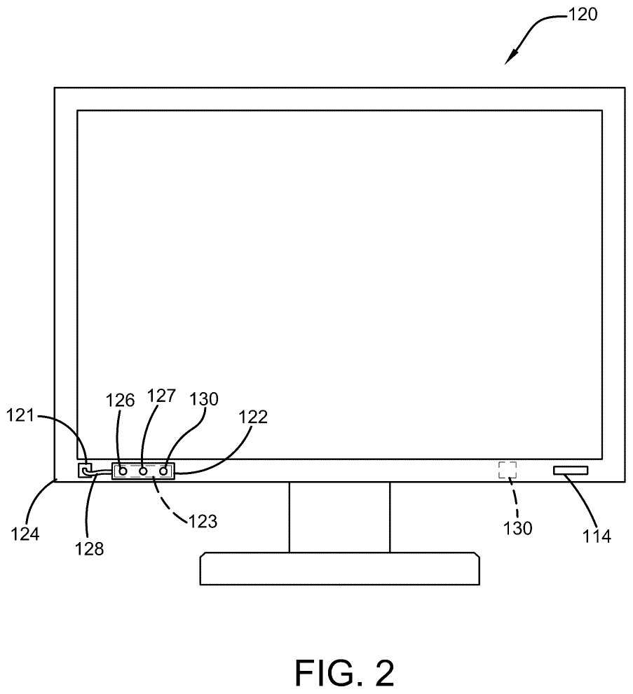

A button 122 may be installed on or integrated within the housing 124 of the television 120. In one embodiment, the button 122 may be integrated during the manufacturing process. In another embodiment, the button 122 may be retrofitted and attached to the television housing 124 using at least one fastener 123 such as but not limited to adhesive mounts, magnetic attachments, threaded fasteners, clips, or hook-and-loop fasteners, as seen in FIG. 2. Pressing the button 122 may trigger a signal directed toward the remote control 102, prompting the speaker 108 to emit a locating tone until the tone is manually deactivated by the user through a repeat activation of the button 122 or an equivalent input.

The button 122 may further include a microphone 126 configured to detect and process spoken commands with a voice recognition module 127 capable of interpreting verbal commands such as but not limited to “find my remote”. Upon successful recognition of the command, the module 127 may transmit a signal to the remote control 102, activating the speaker 108. Additional voice commands may be supported to deactivate the locating tone or perform other control functions. Power to the button 122 may be provided through an adapter 128. The adapter 128 may be configured for connection to a port 121 of the television 120, such as but not limited to a USB port, an HDMI port, etc.

At least one wireless transceiver 130 may be integrated into one or more components of the system 100, as seen in FIG. 1 and FIG. 2. In various embodiments, the wireless transceiver 130 may be embedded in the remote control 102, the television 120, the button 122, or any combination thereof. The transceiver 130 may support Bluetooth, Zigbee, Wi-Fi, or other wireless communication protocols.

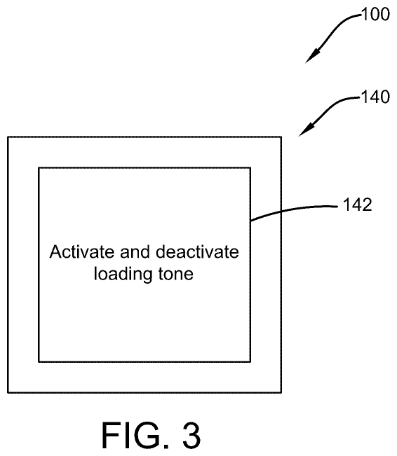

The system 100 may further be comprised of a smartphone application 140, as seen in FIG. 3. The application 140 may include a graphical user interface that enables a user to interact with the system 100. A first feature 142 of the application 140 may allow a user to activate and deactivate a locating tone from the speaker 108 using either a touch input or a voice command processed by the smartphone's onboard voice recognition system. The application 140 may be configured to communicate with the system 100 through a wireless protocol compatible with the transceiver 130.

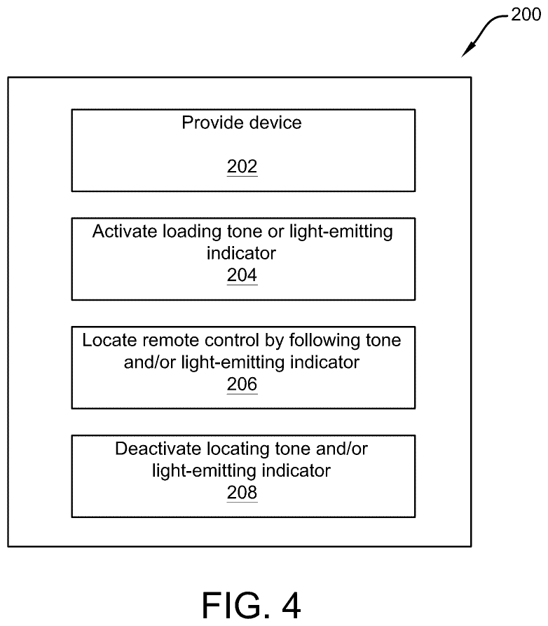

The present invention is also comprised of a method of using 200 the system 100, as seen in FIG. 4. First, a system 100 is provided comprised of a remote control 102 comprised of a speaker 108 and optionally a light-emitting indicator 158, wherein the remote control 102 communicates with a television 120, and further comprising a button 122 integrated into or attached to the television 120 comprised of a microphone 126 and a voice recognition module 127, and a smartphone application 140 configured with a graphical user interface for remote activation of the speaker and light-emitting indicator 158 [Step 202]. Then, a user may activate a locating tone from the speaker 108 by providing an input through at least one of the following interfaces: a button 122 integrated into the television 120, a voice command detected by a microphone 126 associated with a voice recognition module 127, and/or a graphical user interface presented on a smartphone application 140 [Step 204]. Next, the user locates the remote control 102 by following the audible locating tone emitted from the speaker 108 and/or by a flashing light from the light-emitting indicator 158 [Step 206]. The user may then deactivate the locating tone and/or indicator 158 by reactivating the button 122, providing an equivalent user input via the application 140, or issuing a recognized voice command through the microphone 126 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “television remote locating system” and “system” are interchangeable and refer to the television remote locating system 100 of the present invention.

Notwithstanding the foregoing, the television remote locating system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the television remote locating system 100 as shown in the FIGS. are for illustrative purposes only, and that many other sizes and shapes of the television remote locating system 100 are well within the scope of the present disclosure. Although the dimensions of the television remote locating system 100 are important design parameters for user convenience, the television remote locating system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A television remote locating system comprising:
a remote control comprising a speaker, wherein the speaker is configured to emit an audible tone in response to a receiving a signal;
a television;
a button positioned on the television, wherein the button is configured to transmit the signal to the remote control; and
wherein the speaker is configured to emit the audible tone repeatedly until manually or automatically deactivated by the button.

2. The television remote locating system of claim 1, wherein the remote control is comprised of a light-emitting indicator.

3. The television remote locating system of claim 1, wherein the light-emitting indicator flashes in synchronization with the audible tone.

4. The television remote locating system of claim 1, wherein the button attaches to the television via a fastener.

5. The television remote locating system of claim 1, wherein the button is integrally formed into the television.

6. The television remote locating system of claim 1, wherein the button is comprised of a microphone and a voice recognition module.

7. The television remote locating system of claim 1 further comprised of an adapter that powers the button.

8. The television remote locating system of claim 7, wherein the adapter attaches to the port of a television.

9. A television remote locating system comprising:
a remote control comprising a speaker, wherein the speaker is configured to emit an audible tone in response to a receiving a signal;
a television;
a button positioned on the television, wherein the button is configured to transmit the signal to the remote control;
a smartphone application comprising a graphical user interface configured to transmit the signal to the remote control; and
wherein the speaker is configured to emit the audible tone repeatedly until manually or automatically deactivated by the button or the smartphone application.

10. The television remote locating system of claim 9, wherein the remote control is comprised of a light-emitting indicator.

11. The television remote locating system of claim 9, wherein the light-emitting indicator flashes in synchronization with the audible tone.

12. The television remote locating system of claim 9, wherein the button attaches to the television via a fastener.

13. The television remote locating system of claim 9, wherein the button is integrally formed into the television.

14. The television remote locating system of claim 9, wherein the button is comprised of a microphone and a voice recognition module.

15. The television remote locating system of claim 9 further comprised of an adapter that powers the button.

16. The television remote locating system of claim 15, wherein the adapter attaches to the port of a television.

17. The television remote locating system of claim 9, wherein the audible tone is comprised of a modulated beep, a musical tone, a spoken prompt, or a frequency sweep.

18. The television remote locating system of claim 14, wherein the voice recognition module is configured to detect a voice command and transmit the signal to the remote control in response to the voice command.

19. The television remote locating system of claim 9, wherein the remote control is comprised of a charging port.

20. A method of using a television remote locating system, the method comprising the following steps:
providing a system comprising a remote control comprising a speaker and a light-emitting indicator, the remote control being in communication with a television, a button comprising a microphone and a voice recognition module, and a smartphone application configured with a graphical user interface for remote activation of the speaker and the light-emitting indicator;
activating a locating tone from the speaker by providing an input through the button, a voice command detected by the microphone and recognized by the voice recognition module, or the graphical user interface; and
locating the remote control by following the locating tone and a flashing light from the light-emitting indicator.
